(19) United States
(12) Patent Application Publication
(10) Pub. No.: US 2021/0317037 A1
(43) Pub. Date: Oct. 14, 2021

(54) DRY COMPOSITION FOR AN INTERIOR WALL COVERING

(71) Applicant: STYLISH RAINBOW WALLCOVERING LTD., North Vancouver (CA)

(72) Inventor: Shohreh PEIMAN, North Vancouver (CA)

(21) Appl. No.: 16/844,161

(22) Filed: Apr. 9, 2020

(51) Int. Cl. C04B 20/00; B44C 7/00; C04B 40/00; C04B 24/38

(52) U.S. Cl. CPC C04B 20/0048; B44C 7/00; C04B 2111/00637; C04B 24/383; C04B 20/0012; C04B 40/0042

(57) ABSTRACT

A dry composition for a wall covering for interior walls can have a food additive as a binding agent to bind cotton and paper. The dry composition can be mixed with an appropriate amount of water and allowed to set to create a paste. The paste can then be applied to a surface of an interior wall. Once cured, the paste forms a solid layer of a decorative coating on the surface of the interior wall. A color of the decorative layer can be varied by altering the color of the cotton, color of the paper, and the addition of pigments to the paste. A texture of the decorative layer can be varied by altering the amount of cotton, and the size of the cotton pieces used in the dry composition.

### FIELD

Embodiments of the invention relate to wall coverings and more particularly to dry compositions that can be dissolved in water for forming a paste to apply to a surface of an interior wall in the construction industry.

### BACKGROUND

Walls can be decorated in a myriad of different ways, but most often are decorated using one of the three common methodologies of using paint, wallpaper or plaster. All three known methods have distinct drawbacks of being messy, requiring additional preparation of the walls, producing noxious fumes, and are not readily repairable.

Painting a wall is probably the most common form of decorating a wall. Paint is any pigmented liquid, liquefiable, or mastic composition that, after application to a wall or substrate in a thin layer, converts to a solid film. It is most commonly used to protect, color, or provide texture to objects. Paint can be made or purchased in many colors—and in many different types, such as watercolor or synthetic. Paint is typically stored, sold, and applied as a liquid, but most types dry into a solid. Most paints are either oil-based or water-based, each having distinct characteristics with advantages and disadvantages. For example, due to environmental concerns, many municipalities have ordinance regulating or even prohibiting the discarding of oil-based paint down household drains or sewers. Solvents for cleaning up are also different for water-based paint than they are for oil-based paint. Water-based paints and oil-based paints will cure differently based on the outside ambient temperature of the object being painted, such as a house. While water-based paints are more often than not, less odorless than oil-based paints, they still, nonetheless, produce fumes that may be noxious to individuals.

Painted walls can chip, can fade, and are not easily repairable if damage occurs. Often, when there is a damaged section of a painted wall, an entire wall has to be repainted, and not just a section of the wall, due to fading of the paint over time. Further to apply a coat of paint to a surface of a wall, the surface must be treated prior to the application of the paint, substantially increasing time, effort and costs associated with painting a wall.

The technique of applying a wallpaper to decorate a wall is an alternative to painting a well. Wallpaper is a material used in interior decoration to decorate the interior walls of buildings. It is usually sold in rolls and applied onto a wall using chemical adhesives. Wallpapers can come plain as “lining paper” (so that it can be painted or used to help cover uneven surfaces and minor wall defects thus giving a better surface), textured, with a regular repeating pattern design, or, much less commonly today, with a single non-repeating large design carried over a set of sheets.

Wallpaper printing techniques include surface printing, gravure printing, silk screen-printing, rotary printing, and digital printing. Wallpaper is made in long rolls which are hung vertically on a wall. Patterned wallpapers are designed so that the pattern “repeats”, and thus pieces cut from the same roll can be hung next to each other so as to continue the pattern without it being easy to see where the join between two adjacent pieces occurs. In the case of large complex patterns of images, this is normally achieved by starting the second piece halfway into the length of the repeat, so that if the pattern going down the roll repeats after 24 inches, the next piece sideways is cut from the roll to begin 12 inches down the pattern from the first.

Applying a wallpaper to decorate a wall is labor intensive. An adhesive, often a chemical compound having noxious fumes is applied to a surface of a wall, and then the wallpaper is layered on top of the adhesive chemical compound, sandwiching the adhesive chemical compound between the wallpaper and the surface of the wall. This adhesive chemical compound is then trapped behind the wallpaper until the wallpaper and adhesive is removed at a future date. The adhesive chemical compound can leach into the wall, or even worse, leach into and through the wallpaper. Furthermore, if wallpaper is damaged, the damaged section cannot be simply replaced, and entire sections of walls must be replaced. Finally, wallpaper can only be applied to surfaces that are relatively smooth, and cannot be applied to surfaces such as rock, brick, stucco, and plaster.

Plaster is a building material used for the protective or decorative coating of walls and ceilings and for molding and casting decorative elements. Plaster is often used interchangeably with the term stucco.

The most common types of plaster mainly contain either gypsum, lime, or cement, but all work in a similar way. The plaster is manufactured as a dry powder and is mixed with water to form a stiff but workable paste immediately before it is applied to the surface. The reaction with water liberates heat through crystallization and the hydrated plaster then hardens after it is applied to a wall.

Plaster can be relatively easily worked with metal tools or even sandpaper, and can be molded, either on site or to make pre-formed sections in advance, which are put in place with adhesive. Plaster is not a strong material, and is more suitable for finishing, rather than load-bearing, and when thickly applied for decoration may require a hidden supporting framework, usually in metal.

As the different forms of plaster are usually cementitious, and forms lots of dust after is it applied, plaster is more often used for outdoor applications. For indoor, use, plaster is rather formed into pre-formed sections in advance, dried, and then placed on a surface of an interior wall using chemical adhesives. This is advantageous over wallpaper in that the chemical adhesives cannot leach through plaster. However, cracks, holes, scratches and other forms of damage formed on the per-formed plaster requires a replacement of entire sections of the wall in order to maintain consistency.

### SUMMARY

Embodiments of this invention generally relate to a dry composition for an interior wall covering, and more particularly to a dry composition for an interior wall covering comprising a food additive. Embodiments of the invention do not require preparation of a surface of an interior wall prior to the application of the wall covering, and allow damages, such as cracks, holes, scratches, and other forms of surface damage to be repaired relatively easily and quickly.

Embodiments of the invention are composed of natural and environmentally friendly materials, are recyclable and allow interior walls to breathe, reducing moisture and the likelihood of the growth of mold. Embodiments are odorless, and provide thermal and sound insulation. In embodiments, waste or scrap cotton from the textile industry, and/or waste cotton yarn can be used and recycled.

In a broad aspect of the invention, a dry composition for an interior wall covering consists of a food additive which can be mixed with water to form a paste and applied to a surface of an interior wall.

### DETAILED DESCRIPTION

Generally, embodiments of the present invention relate to a dry composition for an interior wall covering which can be mixed in an appropriate amount of water to form an emulsion or paste. The paste can then be applied to an interior wall surface and allowed to be cured. Once cured, the paste forms a solid layer of decorative wall covering that provides various aesthetic appreciations. Depending on the nature of the ingredients of the dry composition, embodiments of the present invention consists of natural ingredients and is environmentally friendly, easy to work with, easy to clean up, and children safe. In embodiments, the resulting decorative wall covering provides increased thermal and sound insulation and reduces the buildup of moisture therein, thereby reducing the likelihood of the growth of mold.

In use, embodiments of the dry composition can be mixed with an appropriate amount of water to create a paste. The paste, once it achieves a desired consistency, can be applied to any surface of a wall (such as an interior wall, ceiling, painted wall, metal wall, glass walls, cement walls, brick walls, tile walls, stone wall, wood walls, and rough textured walls like popcorn ceilings, plaster ceilings an stucco) using various means. In an embodiment, the use of a trowel was found to be most effective. In other embodiments, a roller can also be used to apply the wet composition onto the surface of the interior wall. In embodiments, a combination of the roller to apply the wet composition onto the surface of the wall can be employed, followed by the use of the trowel to evenly distribute and stretch the wet composition on the surface of the interior wall.

Once the paste is applied to the surface of the wall, the paste is allowed to cure or dry to form a solid decorative layer on the surface of the interior wall. Once the paste is fully cured, the decorative layer forms a solid wall coating that is odorless, non-corrosive, and provides additional sound and thermal insulation.

Advantageously, Applicant notes that the final dried decorative wall covering is also non-flammable. Applicant conducted experiments to determine flammability and noted that when exposed to direct fire and flames, the area of the decorative wall covering that is exposed turned black but did not ignite and spread the fire.

In an embodiment, 3 to 6 liters of water can be mixed with 1 kilogram of the dry composition and allowed to set for about 25 minutes. Although the wet composition can be allowed to set longer, Applicant has found that allowing the dry composition to set in water for about 25 minutes provides the best consistency and fluidity of the paste to allow for easier application of the paste onto a surface of an interior wall. The paste can be applied using a plastic trowel commonly used in the application of dry wall mud. As the paste is applied to the surface, a person can use the trowel to evenly distribute the paste across the entire surface of the wall. In situations where the paste is found to be too viscous to apply evenly, additional water can be added to reduce the overall viscosity of the paste. If the paste is too fluid, additional dry composition can be added to the paste to increase the viscosity of the paste. In embodiments, if the wet composition is not applied to the surface of the interior wall, and there remains unused or non-applied portions of the wet composition which has thickened or even hardened, additional water can be added to the unused portions of the wet composition to decrease the viscosity of the unused portions and then applied to the surface of the wall.

In embodiments, unused portions of the wet composition can be stored indefinitely and can then be reused by simply adding water. For example, after an application of the wet composition is completed, the unused portion or any left over wet composition can be stored in a suitable container. In embodiments, this left over portion can even be allowed to completely dry. If there is a need to use some of the unused portion at a future date, the dried unused portion can be reused by simply adding additional water to make it fluid.

In embodiments, the Applicant has found that applying a 1 to 3 mm thick coat of the paste provides optimal coverage and use of the paste. Applicant notes that the time to dry the wet composition depends on the thickness of the wet composition applied, such that a thinner layer of wet composition requires less time to dry and conversely, a thicker layer of wet composition requires more time to dry.

After the paste has been applied to the wall surface, it can be allowed to cure or dry until the paste forms a solid decorative coating. In embodiments, the Applicant has found that allowing the paste to cure for about 48 hours at a temperature of between 20° C. to 30° C. with adequate air circulation resulted in optimal performance. Applicant notes that increase in the ambient or room temperature increases the fluidity (i.e. reduces the viscosity) of the wet composition, making it more difficult to apply the wet composition to the surface of the interior wall. Similarly, applying the wet composition at lower ambient temperatures increases the viscosity such that application of the wet composition is hindered.

In embodiments, if a need to remove portions of the decorative wall covering arises, such as due to damage, Applicant has found that simply wetting the decorative wall covering with water allows the wetted portions to be removed. Once the damaged portions are removed, fresh wet composition can be applied to repair the damaged portions of the decorative wall covering. In embodiments, the removed wet composition can be recycled and reused at a later date. For example, Applicant has found that spraying a localized area having damage with water and allowing the water to soak into the decorative wall covering between 15 to 20 minutes allows that particular portion to be scrapped off. This portion can then be repaired by reapplying a new layer of the wet composition, which can be freshly made, or a dried unused portion that has water added to it.

Accordingly, Applicant notes that embodiments of the present invention should not be applied to areas or surfaces of walls that are near areas with high moisture content, such as showers, or exterior walls.

Embodiments of the dry composition consists of several ingredients, each ingredient serving a different purpose. In an embodiment, there are three ingredients which the dry composition consists of: 1) cotton; 2) paper; and 3) a food ingredient for binding the cotton onto the surface of an interior wall.

In embodiments, cotton is included in the composition to give texture, aesthetic and visual decorative properties, and provide insulative properties (ie. Thermal and sound insulation). In embodiments, depending on the desired aesthetic properties, the cotton can be shredded of various sizes and color. In embodiments, the shredded cotton can be of a unitary size, a unitary color, or can be a variation thereof. Further still, in other embodiments, while polyester can be used, in order to reduce the environmental footprint, waste cotton from the fabric industry and/or cotton yarn can be used. In other embodiments, spun silk, or tram silk yarn are alternatives to using cotton.

The second ingredient of paper, although optional, can be included to serve as a binder for the shredded pieces of cotton. In embodiments, the paper should break down to serve as a binder, and accordingly, the paper is shredded paper. In embodiments, paper can be substituted with paper towels, which results in a final decorative wall covering having a different texture.

The final required ingredient is an adhesive for binding the cotton to the surface of the interior wall. Applicant understands and is aware of prior art that uses chemical adhesives. For example, Applicant can use wallpaper paste, a common chemical adhesive, but this is not the goal of the Applicant in providing an all-natural and environmentally friendly wall covering.

From Applicant's previous experience as an interior designer, the Applicant recalled working on various projects creating and designing home accessories made from environmentally friendly products. The Applicant sought to find a dry composition, made from all naturally and environmentally friendly products, that can be used to create a wall covering for interior walls. Recalling the Applicant's past experiences, Applicant attempted to create embodiments of the invention using a food ingredient, such as flour, as the third ingredient for binding the cotton to the wall.

Experimentation using flour was somewhat successful in that the final dried decorative wall covering this adhere to the surface of the wall. However, the Applicant noted that the wall covering was easily removed from the wall upon drying. Continuing along the lines of using a food ingredient for adhesion, the Applicant experimented with corn starch, another food ingredient. The results were similar in that the final dried wall covering was easily removed from the surface of the wall. Other food ingredients that were used in obtaining a final formulation included calcium citrate malate, and ingredient used in fortifying calcium in dairy products, namely ice cream, and cellulose gum, another ingredient used in the ice cream manufacturing industry. Applicant found that the cellulose gum provided the best results with respect to consistency of the wet composition for application onto a surface of an interior wall, softness of the final product after application and hardness and resiliency of the final decorative wall covering.

Advantageously, Applicant noticed that cellulose gum also does not promote bacterial growth, whereas flour and corn starch did. As described above, Applicant used food ingredients that were readily available and found in the Applicant's pantry. Applicant notices that mold and moths were found in the flour and the corn starch, after long term storage, however, no such growth was found in the stored cellulose gum.

Upon determining an appropriate food ingredient to act as the adhesive, Applicant experimented with various concentrations or ratios of each ingredient to provide the most desirable final decorative wall covering. The table below illustrates the various amounts of each ingredient used and the resulting subjective test results.

| Formulation Used | |
|---|---|
| (cotton-paper-cellulose | |
| gum wt:wt:wt) | Relative Texture |
| 80%-10%-10% | Softest |
| 70%-10%-20% | About the same softness as 70% cotton with |
| | 20% paper |
| 70%-20%-10% | Softer than 60% cotton |
| 60%-20%-20% | Softer than 45% cotton |
| 45%-45%-10% | Softer than 0% cotton |
| 0%-90%-10% | Hard |
| 0%-80%-20% | Hard |
| 90%-0%-10% | Not as soft as 80% cotton paper and 10% paper |

Importantly, the Applicant did not notice any difference in the ability of the wet composition to adhere to the surface of the interior wall when 20% cellulose gum was used when compared with 10% cellulose gum used. Thus, the experimental data suggests that using about 10% cellulose gum is just as effective as using 20% cellulose gum. However, Applicant noted that an increase in the cellulose gum used resulted in a final decorative wall covering that was not as soft as the final decorative wall covering when 10% of cellulose gum was used.

Furthermore, as one can see from the data above, generally, the resulting decorative wall covering increases in softness as more cotton is used in the formulation. However, when 90% of cotton without paper is used, the final decorative wall covering is not as soft as compared to the 80% of cotton and 10% paper. Similarly, Applicant noted that the softness of the final decorative wall covering decreased as more paper was used in the dry composition.

Although further experiments are required, Applicant postulates that beyond 80% cotton, paper is required to increase the softness of the final decorative wall covering.

In embodiments a method for manufacturing the dry composition consists of providing shredded cotton by shredding cotton in a shredding machine. In an embodiment, the shredding machine for the cotton can have two steel blades rotating concurrently in a clockwise direction. The distance of the blades can be varied to produce different sizes of the shredded cotton. In an embodiment, the cotton shredding machine can operate to shred at least 1,000 kg per day. In embodiments, a variation of the cotton shredder can be adapted and used to shred paper.

In embodiments, the method for manufacturing the dry composition further consists of providing shredded paper and mixing the shredded cotton, shredded paper and the food additive in an appropriately sized container. In one embodiment, the shredded cotton, shredded paper, and the dry food ingredient can be mixed in a mixing machine for about 30 minutes, and then packaged for storage or transportation. Applicant notes that the use of a mixing machine is recommended as the ingredients of the dry composition must be thoroughly mixed as to form a uniform consistency or homogeneity.

In embodiments, to assist with maintaining consistency of the desired color of the final decorative wall covering, white cotton can be dyed with various colored pigments using technology and methodology known in the art.

1. A dry composition for the preparation of a wet composition for use as an interior wall covering consisting of a food ingredient.

2. The dry composition of claim 1, further consisting of cotton.

3. The dry composition of claim 2, further consisting of paper.

4. The dry composition of claim 3, wherein the ratio of cotton:paper:food ingredients is 45:45:10.

5. The dry composition of claim 3, wherein the ratio of cotton:paper:food ingredienst is 70:20:10.

6. The dry composition of claim 3, wherein the ratio of cotton:paper:food ingredients is 80:10:10.

7. The dry composition of claim 1, wherein the food ingredient is one of calcium citrate malate, corn starch, flour or cellulose gum.

8. The dry composition of claim 6, wherein the food ingredient is cellulose gum.

9. A method of applying the composition of claim 1, consisting the steps of:
mixing the dry composition with water for creating a paste;
allowing the paste to set to an appropriate consistency for application onto a surface of an interior wall; and
applying the paste onto the surface of the interior wall for forming a decorative wall covering.

10. The method of claim 9, wherein mixing the dry composition with water further consists of adding 3 to 6 liters volume of water and mixing it with 1 kilogram amount of the dry composition in an appropriately sized container.

11. The method of claim 9, wherein allowing the paste to set to an appropriate consistency is allowing the paste to set for 20-30 minutes at an ambient temperature between 20° C. to 30° C.

12. The method of claim 9, further consisting of allowing the paste to cure on the surface of the wall for about 48 hours to form the decorative wall covering.

13. A method of manufacturing the composition of claim 8, consisting the steps of:
providing shredded cotton;
providing shredded paper;
providing the food additive; and
mixing the shredded cotton, shredded paper and food additive.

14. The method of claim 13, wherein providing the shredded cotton further consists of shredding cotton in a shredding machine to produce shredded cotton of a desired size.

15. The method of claim 14, wherein providing the shredded paper further consists of shredding paper in a shredding machine to produce shredded paper of a desired size.
